(19) United States
(12) Patent Application Publication
(10) Pub. No.: US 2018/0100553 A1
(43) Pub. Date: Apr. 12, 2018

(54) SINGLE SHOE-TYPE BRAKE APPARATUS

(71) Applicants: TAECHUL Industrial Co. LTD, Daegu (KR); Won Bong CHO, Hwa Sung city (KR)

(72) Inventors: Won Bong CHO, Hwa Sung city (KR); Yul Hee LEE, Daegu (KR); Sang Ji LEE, Daegu (KR)

(21) Appl. No.: 15/728,670

(22) Filed: Oct. 10, 2017

(30) Foreign Application Priority Data
Oct. 12, 2016 (KR) 10-2016-0132212

(51) Int. Cl. F16D 51/02; F16D 65/09; F16D 69/04; F16D 65/38

(52) U.S. Cl. CPC F16D 51/02; F16D 65/09; F16D 2051/003; F16D 65/38; F16D 69/0416

(57) ABSTRACT

Disclosed herein is a single shoe-type brake apparatus. The single shoe-type brake apparatus includes: an integrated sideways “U”-shaped single brake shoe configured to form an open ring shape, to be integrated into a single body, and to have a separation region on one side thereof so that it is subjected to external force in a direction where it is extended to both sides thereof; a cylinder installed in the separation region, and configured to provide the external force; and a friction material coupled to the outer circumferential surface of the brake shoe, and installed to selectively come into contact with a brake drum as the brake shoe is extended. The friction coefficient of the friction material is considerably lower than that of a common brake friction material, and a brake factor is almost identical to that of a brake apparatus having two shoes.

### BACKGROUND

### 1. Technical Field

The present invention relates generally to a single shoe-type brake apparatus, and more specifically to a single shoe-type brake apparatus, in which an auxiliary device configured to prevent a brake shoe from leaping is employed, the operation initiation force of the brake shoe can be reduced by means of the brake shoe having a changed shape, and a friction material having a low friction coefficient is employed instead of a commonly commercialized friction material having a high friction coefficient, thereby reducing braking force.

### 2. Description of the Related Art

Generally, brake apparatuses for a vehicle include a main brake configured to reduce the speed of a vehicle during the running of the vehicle and a parking brake configured to maintain the parking state of a vehicle during the stopping of the vehicle.

When a driver reduces the speed of a vehicle or stops the vehicle or when a driver stops and parks the vehicle, a drum-type brake apparatus is installed on the rear axle of the vehicle so as to generate braking force in such a way that a brake shoe inside a brake drum is extended and comes into tight contact with the brake drum.

Generally, common brake apparatuses each include two brake shoes. In contrast, single shoe-type brake apparatuses each have a single-type brake shoe. A single-type brake shoe is a rigid body which generates restoring force, returning the brake shoe to an original state before the application of braking force, when the braking force is released. Accordingly, a single-type brake shoe does not require a restoring spring.

A single shoe-type drum brake is chiefly installed on the rear axle of a vehicle. Generally, a single shoe-type drum brake performs braking in conjunction with a caliper brake configured to perform braking by compressing a disk installed on the front axle of vehicle in the case of a main brake operation, and independently performs braking in the case of a parking brake operation.

However, in the case of a single shoe-type main brake, a friction material becomes worn as the number of braking operations increases, and thus the wear of the friction material increases gradually. In this case, a single-type shoe needs to be further extended in order to perform braking, with the result that the force required for the extension of the single-type shoe, i.e., a rigid body, increases rapidly.

Accordingly, as the wear of the friction material increases, braking initiation force increases rapidly. When a driver slowly reduces the speed of a vehicle during the running of the vehicle, a caliper brake installed on the front axle of the vehicle operates, but a single shoe-type brake installed on the rear axle of the vehicle does not operate, with the result that braking distance increases. Furthermore, additional problems may arise in that braking stability is degraded, the friction material of the caliper brake installed on the front axle of the vehicle is worn out earlier, and brake fade occurs. Accordingly, it is important for single shoe-type brake to have a structure capable of reducing braking initiation force by reducing the extendibility of a brake shoe.

### PRIOR ART DOCUMENT

### Patent Document

(Patent document 0001) Korean Patent Application Publication No. 10-2015-0018938 (published on Feb. 25, 2015)

### SUMMARY

The present invention has been conceived to overcome the above-described problems, and an object of the present invention is to provide a single shoe-type brake apparatus having an auxiliary device including a back plate, in which extendibility reduction depressions are formed in the inner surface of a sideways “U”-shaped brake shoe in order to reduce braking initiation force rapidly increasing in accordance with the wear of a friction material, and the extension and deformation of the brake shoe are performed via the extendibility reduction depressions in the case of the wear of the friction material, thereby reducing extendibility regarding the separation region of the sideways “U”-shaped brake shoe.

Another object of the present invention is to provide a single shoe-type brake apparatus, in which braking force can be considerably reduced by means of a friction material having a friction coefficient significantly lower than that of a current commercialized friction material in order to meet the requirement in which a reduction in braking force is essential for the application of a single shoe brake as a common main brake for the reason that problems arise in that a rear axle is fastened earlier and an anti-lock braking system (ABS) operates frequently during braking when the single shoe brake having high performance is applied to the rear axle of a vehicle and thus a leading-trailing type brake having two shoes and reduced braking force is commonly applied to the rear axle of the vehicle.

According to an aspect of the present invention, there is provided a single shoe-type brake apparatus, including: an integrated sideways “U”-shaped single brake shoe configured to form an open ring shape, to be integrated into a single body, and to have a separation region on one side thereof so that it is subjected to external force in a direction where it is extended to both sides thereof; a cylinder installed in the separation region, and configured to provide the external force in a direction where the brake shoe is extended toward the separate ends of the brake shoe; and a friction material coupled to the outer circumferential surface of the brake shoe, and installed to selectively come into contact with a brake drum as the brake shoe is extended; wherein the friction coefficient of the friction material is considerably lower than that of a common brake friction material, and a brake factor is almost identical to that of a brake apparatus having two shoes.

According to another aspect of the present invention, there is provided a single shoe-type brake apparatus, including: an integrated sideways “U”-shaped single brake shoe configured to form an open ring shape, to be integrated into a single body, and to have a separation region on one side thereof so that it is subjected to external force in a direction where it is extended to both sides thereof; extendibility reduction depressions formed in portions of the inner surface of the brake shoe opposite to the separation region to have a predetermined shape, and configured to reduce the extendibility of the brake shoe; a cylinder installed in the separation region, and configured to provide the external force in a direction where the brake shoe is extended toward the separate ends of the brake shoe; and a friction material coupled to the outer circumferential surface of the brake shoe, and installed to selectively come into contact with a brake drum as the brake shoe is extended; wherein the friction coefficient of the friction material is considerably lower than that of a common brake friction material, and a brake factor is almost identical to that of a brake apparatus having two shoes.

The extendibility reduction depressions may be formed in one or both of the inner surfaces of rails of the sideways “U”-shaped shoe, and may have corrugated portions including arcs whose heights are different.

The extendibility reduction depressions may be formed in one or both of the front and rear portions of the rails of the sideways “U”-shaped, may have an identical shape and structure or different shapes and structure, and may be formed at an identical height or different heights.

Both side ends of the extendibility reduction depressions may be formed in a terminal shape or a step shape, or may be formed in a moderate elliptical shape or an arcuate shape having a slight slope.

An auxiliary device support portion may be formed between the extendibility reduction depressions.

An auxiliary device support portion may be formed on one or both of the front and rear portions of the sideways “U”-shaped shoe.

The extendibility reduction depressions may be formed in the front and rear portions of the sideways “U”-shaped shoe, and the depths of the extendibility reduction depressions may be identical to or different from each other.

The extendibility reduction depressions may be formed to have differences in height, may be formed to have stepwise differences in height, or may be famed in various shapes, such as an elliptical shape or a circular shape, in accordance with the performance of a brake.

The extendibility reduction depressions may be formed without an auxiliary device support portion, and may satisfy the relationship 1/3<h2/h1<3, wherein the height of rails in the extendibility reduction depressions is h1 and the depth of the extendibility reduction depression is h2.

According to still another aspect of the present invention, there is provided a single shoe-type brake apparatus, including: an integrated sideways “U”-shaped single brake shoe configured to form an open ring shape, to be integrated into a single body, and to have a separation region on one side thereof so that it is subjected to external force in a direction where it is extended to both sides thereof; extendibility reduction depressions formed in portions of the inner surface of the brake shoe opposite to the separation region to have a predetermined shape, and configured to reduce the extendibility of the brake shoe; a cylinder installed in the separation region, and configured to provide the external force in a direction where the brake shoe is extended toward the separate ends of the brake shoe; a friction material coupled to the outer circumferential surface of the brake shoe, and installed to selectively come into contact with a brake drum as the brake shoe is extended; and an auxiliary device configured to prevent the brake shoe from leaping when the brake shoe is extended by the operation of the cylinder; wherein the friction coefficient of the friction material is considerably lower than that of a common brake friction material, and a brake factor is almost identical to that of a brake apparatus having two shoes.

The auxiliary device may be formed on one side or the other side of the sideways “U”-shaped brake shoe.

The auxiliary device may include: a support plate located upright on the bent end of the extendibility reduction depressions; and a fastening member configured to fasten the support plate and the back plate while passing through the support plate and the back plate in the state of supporting the bent end of the extendibility reduction depressions via the support plate and the back plate configured to support the brake shoe.

The extendibility reduction depressions may include corrugated portions formed along portions of the inner surface of the brake shoe opposite to the separation region.

The length and height of an auxiliary device support portion formed between the extendibility reduction depressions may be determined based on the strength and extendibility of the brake shoe.

The friction coefficient of the friction material may be equal to or lower than 0.25.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a front view showing a single shoe-type brake apparatus according to a first embodiment of the present invention;

FIG. 2 is a sectional view showing the shoe of the single shoe-type brake apparatus according to the first embodiment of the present invention in the circumferential direction thereof;

FIG. 3 is a view showing the extension deformation section of a single shoe-type brake apparatus according to a second embodiment of the present invention;

FIG. 4 is a view showing the single shoe-type brake apparatus according to the second embodiment of the present invention;

FIG. 5 is a sectional view showing the extendibility reduction depressions of the shoe of the single shoe-type brake apparatus according to the second embodiment of the present invention in the circumferential direction thereof;

FIG. 6 is a perspective view showing a single shoe brake apparatus according to a third embodiment of the present invention;

FIG. 7 is a front view showing a single shoe-type brake apparatus according to a fourth embodiment of the present invention;

FIG. 8 is a sectional view showing the shoe of the single shoe-type brake apparatus according to the fourth embodiment of the present invention in the circumferential direction thereof;

FIG. 9 is a view showing the extendibility reduction depressions of a single shoe-type brake apparatus including an auxiliary device support portion according to a fifth embodiment of the present invention;

FIG. 10 is a detailed perspective view showing the extendibility reduction depressions and auxiliary device support portion of the single shoe-type brake apparatus according to the fifth embodiment of the present invention;

FIG. 11 is a view showing extendibility reduction depressions configured to prevent a brake shoe from leaping during the extension of the brake shoe in the single shoe-type brake apparatus according to the fifth embodiment of the present invention;

FIG. 12 is a graph showing relationships between shoe displacements and braking initiation forces in a friction material according to the present invention; and

FIG. 13 is a graph showing relationships between friction coefficients and brake factors in a friction material according to the present invention.

### DETAILED DESCRIPTION

Embodiments of the present invention will be described in detail below with reference to the accompanying drawings.

The advantages, features, and aspects of the present invention will become apparent from the embodiments which will be described in detail below in conjunction with the accompanying drawings.

However, the present invention is not limited to the embodiments disclosed below, but may be implemented in various different forms. The present embodiments are provided merely to complete the disclosure of the present invention and to enable those having ordinary knowledge in the art to which the present invention pertains to understand the scope of the invention. The scope of the present invention is defined only by the scopes of the attached claims.

Furthermore, in the following description of the present invention, when it is determined that a detailed description of a related well-known technology may make the gist of the present invention obscure, the detailed description will be omitted.

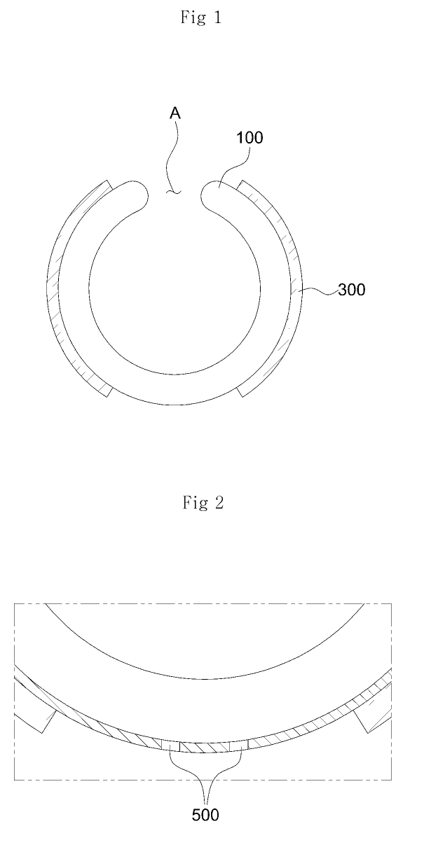

FIG. 1 is a front view showing a single shoe-type brake apparatus according to an embodiment of the present invention, FIG. 2 is a sectional view showing the shoe of the single shoe-type brake apparatus according to the embodiment of the present invention in the circumferential direction thereof. The single shoe shown in FIGS. 1 and 2 has a sideways “U”-shaped section, and coating solution drain holes 500 configured to drain a corrosion inhibitor are formed in the bottom of the center of the shoe.

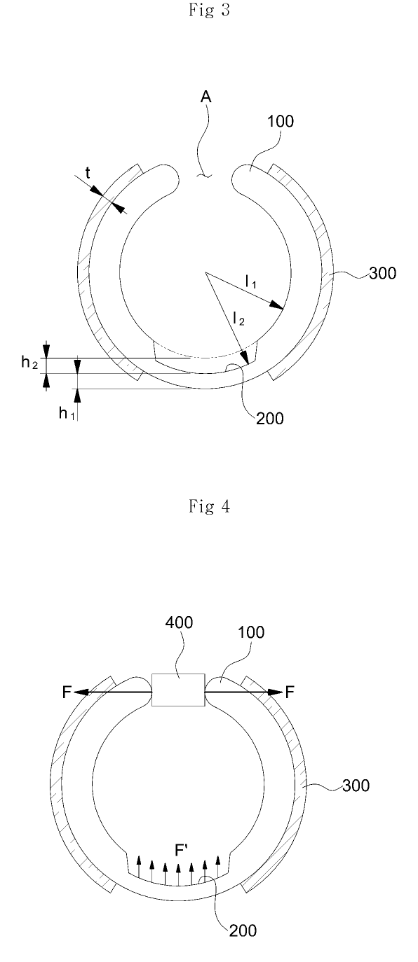

In the section where a brake shoe is extended, as shown in FIG. 3, when the thickness of a friction material is t, a maximum extension distance is 2 t.

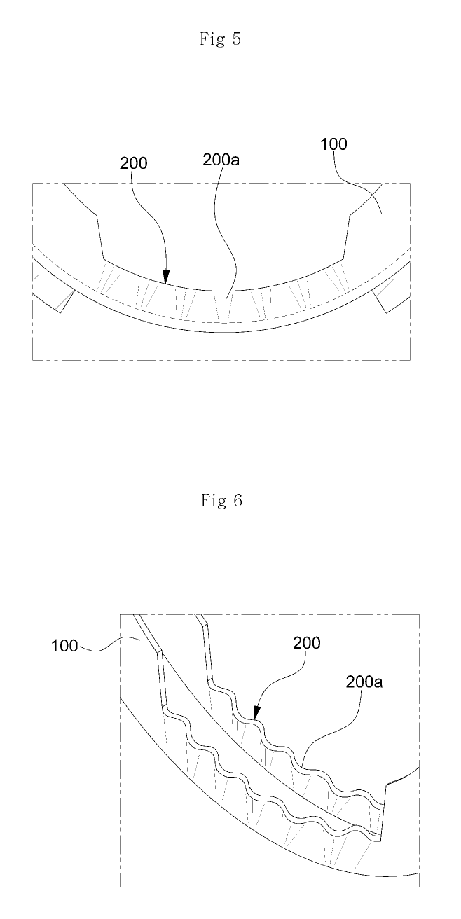

FIG. 4 is a view showing a single shoe-type brake apparatus according to a second embodiment of the present invention, and FIG. 5 is a sectional view showing the extendibility reduction depressions 200 of the shoe of the single shoe-type brake apparatus according to the second embodiment of the present invention in the circumferential direction thereof.

Furthermore, the extendibility reduction depressions 200 are formed in the front and rear portions of the sideways “U”-shaped shoe, and the depths of the extendibility reduction depression 200 may be the same as or different from each other. The reason for this is that they vary depending on the performance and conditions of the brake apparatus.

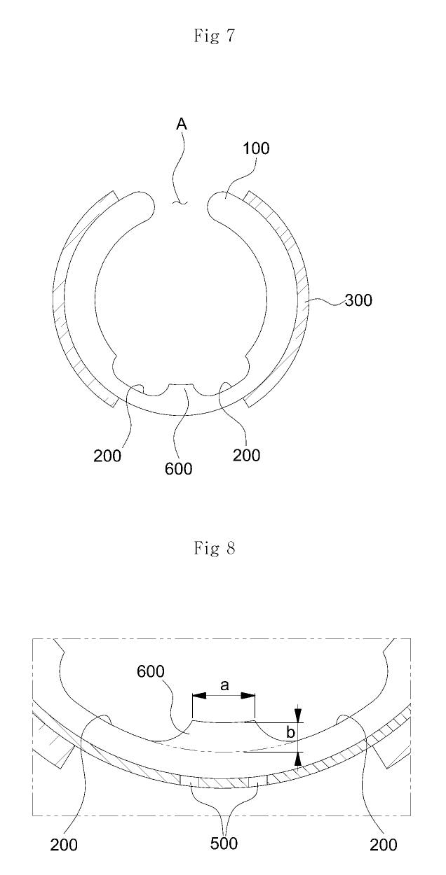

The extendibility reduction depressions 200 may be formed to have differences in height, as shown in FIGS. 6 and 7, may be formed to have stepwise differences in height, or may be famed in various shapes, such as an elliptical shape or a circular shape, in accordance with the performance of a brake.

Furthermore, the extendibility reduction depression 200 may be formed in the shape shown in FIG. 6, or may be formed in various shapes.

A protection device support portion 600 generally supports a protection device B. The length a of the protection device support portion 600 and the height b of the extendibility reduction depressions 200 are determined based on the extendibility of a cylinder and the strength of the brake shoe 100.

This is intended to reduce the operating force of the brake shoe 100 during braking. In other words, the elastic modulus is reduced by reducing the sectional area of the brake shoe 100, and thus stress is minimized via the extendibility reduction depressions 200, which may be formed in various shapes, when the brake shoe 100 is deformed, thereby reducing the extendibility of the brake shoe 100.

The extendibility reduction depressions 200 may include corrugated portions 200a formed along inner surfaces opposite to a separation region A in order to enable the extendibility of the brake shoe 100 to be reduced, as shown in FIGS. 6 and 7.

The corrugated portions 200a are formed to have different heights inside the extendibility reduction depressions 200. The corrugated portions 200a have a structure in which extension occurs easily in a region having a low height due to the above-described shape characteristic, and function as a spring. Accordingly, when the thickness of the friction material is large and thus the gap of the separation region A is extended by the thickness, extendibility can be minimized without plastic deformation, and thus a sufficient linear section attributable to the initiation of the braking force of the brake shoe 100 can be ensured during braking.

As a result, in the present embodiment, the extendibility reduction depressions 200 and the corrugated portions 200a formed in the extendibility reduction depressions 200 are formed, and thus there is provided a structure in which the corrugated portions 200a are spread like a spring when extendibility is generated in the brake shoe 100, thereby preventing the separation region A from being excessively extended even when the wear of the friction material 300 has occurred.

Furthermore, FIG. 7 is a front view showing a single shoe-type brake apparatus according to a fourth embodiment of the present invention. FIG. 8 is a sectional view showing the shoe of the single shoe-type brake apparatus according to the fourth embodiment of the present invention in the circumferential direction thereof.

As shown in FIGS. 7 and 8, the single shoe-type brake apparatus according to the present embodiment includes a brake shoe 100, extendibility reduction depressions 200, a friction material 300, a cylinder 400, drain holes 500, and an auxiliary device support portion 600.

In this case, the configurations of the brake shoe 100, the extendibility reduction depressions 200, the friction material 300, the drain hole 500, and the auxiliary device support portion 600 are the same as the configurations of the above-described embodiment, and thus detailed descriptions thereof are omitted in the description of the present embodiment.

In other words, in the above-described embodiment, the structure of the brake shoe 100 which enables a sufficient linear section attributable to the initiation of braking force to be ensured compared to the conventional single shoe-type brake apparatus which is used as a main brake has been described. There can be provided the structure of the brake shoe 100 which can be used not only as a main brake but also as a parking brake.

In other words, conventionally, a brake apparatus including two brake shoes and a restoring spring has been used as a main brake and a parking brake. The conventional brake apparatus is problematic in that the structure thereof is complex due to the combination of the two brake shoes and the restoring spring and the weight and cost thereof increase.

Accordingly, in the present embodiment, the separation region A is formed, and the cylinder 400 is installed in the separation region A. The cylinder 400 is installed, and the separation region A is extended by the operation of the cylinder 400 during braking. Returning to an original location is performed via the extendibility reduction depressions 200 during the running of a vehicle. Accordingly, the single shoe-type brake apparatus according to the present invention can be effectively used as a main brake and a parking brake without requiring the configurations of a separate restoring spring and two brake shoes, unlike the conventional brake apparatuses.

Furthermore, the brake factor of a brake which is applied when the single shoe-type brake apparatus is applied is large, and thus braking force becomes excessively larger than required braking force. However, this problem can be resolved through the adjustment of the friction coefficient of the friction material 200. In the case of a rear wheel brake for a passenger vehicle, a spin of the vehicle occurs when a rear wheel is fastened (a rear wheel slip) during braking, and thus an ABS is applied in order to prevent the problem. Meanwhile, in the case of an integrated single shoe brake, when a friction material having a friction coefficient (commonly equal to or larger than 0.3) which is currently being used as a duo servo type brake is applied, a rear wheel is locked even during low-speed reduction braking due to the large brake factor of the brake, and thus an ABS operates frequently, thereby limiting the application thereof. Accordingly, the function of the present single shoe-type braking apparatus can be implemented only when a low friction coefficient (equal to or lower than 0.25) is applied. Braking force can be prevented from being excessively increased due to a large brake factor by applying a friction material having a low friction coefficient, thereby enabling the single shoe-type brake apparatus to operate. Accordingly, a single shoe-type brake which has been used only as a parking brake can be used as a main brake (a service brake), thereby enabling the present invention to be applied not only as a main brake but also as a parking brake.

Accordingly, the present invention cannot be implemented if both the extendibility reduction depression 200 and a friction material having a low friction coefficient are not provided. Therefore, the extendibility reduction depressions 200 and the friction material having a low friction coefficient can be viewed as the core technologies of the present invention.

FIGS. 7 and 8 show the single shoe-type brake apparatus according to the fourth embodiment of the present invention, which includes the brake shoe 100, the extendibility reduction depressions 200, the friction material 300, the drain holes 500, and the auxiliary device support portion 600. In this case, the length of the auxiliary device support portion 600 is a, and the height of the auxiliary device support portion 600 from the bottoms of the extendibility reduction depressions 200 is b. The height b is determined based on the extendibility F of the cylinder and the strength of the brake shoe 100.

First, the brake shoe 100 forms an open ring shape, is integrated into a single body, and has a separation region A on one side thereof so that it is subjected to external force in a direction where it is extended to both sides thereof.

Furthermore, the brake shoe 100 has a sideways “U” shape chiefly including front and rear portions in order to reduce weight and extendibility. The brake shoe 100 further includes the drain holes 500 configured to drain a coating solution used to prevent the corrosion of the shoe, an auxiliary device (see FIG. 11) configured to prevent the shoe from leaping, and the auxiliary device support portion 600.

In other words, the brake shoe 100 is of a single shoe type. Accordingly, compared to the conventional structure having two brake shoes, the brake shoe 100 has a simple structure and can reduce the weight and cost thereof because it does not require the configuration of a separate restoring spring. Referring to FIGS. 3 and 4, a problem arises in that only a front wheel caliper brake generates braking force and a rear wheel brake does not operate due to a rapid increase in operation initiation force attributable to the wear of the friction material 300 based on its structural characteristic, and thus the single brake shoe-type braking apparatus cannot be used as a main brake but can be used only as a parking brake, with the result that the a limitation on use occurs.

Furthermore, when the friction material 300 is worn out, the gap of the separation region A is extended by the width of the friction material 300 due to its material characteristics because the brake shoe 100 is made of steel. The operation force of the brake apparatus is increased due to the extension of the gap of the separation region A, which may result in a rapid increase in braking initiation force.

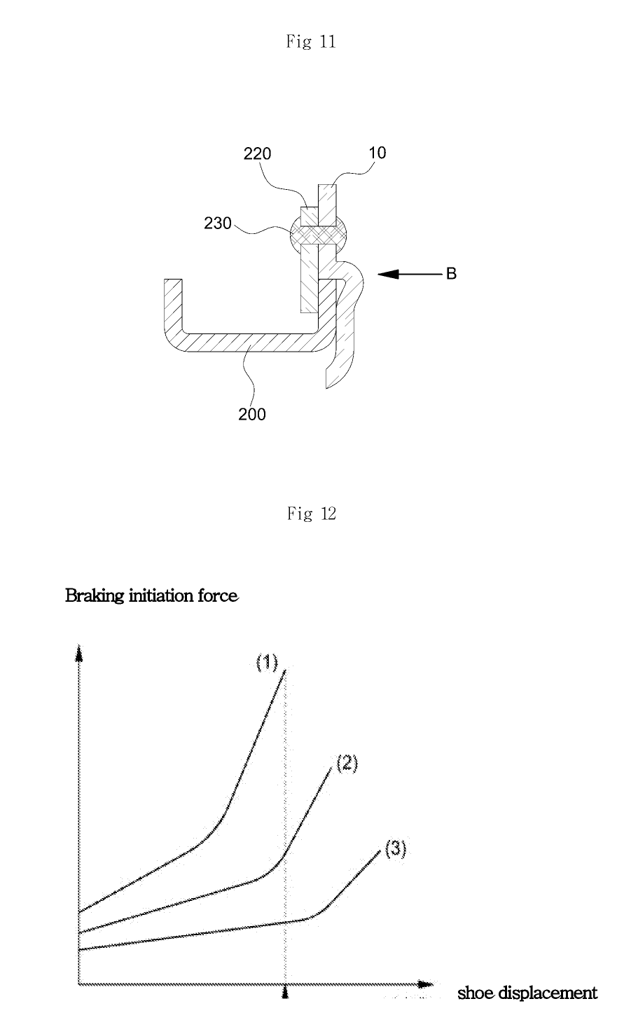

In order to deal with this problem, according to the present embodiment, the extendibility reduction depressions 200 are formed in the inner surface of the brake shoe 100 opposite to the separation region A, and the auxiliary device support portion 600 configured to support the auxiliary device (see FIG. 12) is formed between the extendibility reduction depressions 200. Accordingly, when the separation region A is excessively extended by the cylinder 400 due to the wear of the friction material 300, the extendibility of the brake shoe 100 can be reduced.

In other words, the extendibility reduction depressions 200 are famed in a region opposite to the separation region A.

The extendibility reduction depressions 200 are formed in the front and rear portions of the sideways “U”-shaped brake shoe 100, the auxiliary device support portion 600 configured to support the auxiliary device is formed between the extendibility reduction depressions 200, and the coating solution drain holes 500 configured to drain a shoe corrosion inhibitor are formed.

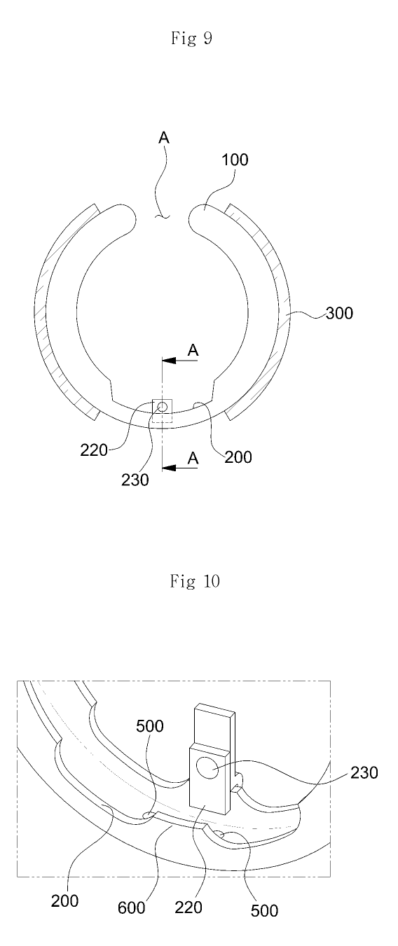

Furthermore, FIG. 9 is a view showing a single shoe-type brake apparatus including an auxiliary device support portion 600 according to a fifth embodiment of the present invention. FIG. 10 is a detailed perspective view showing the extendibility reduction depressions and auxiliary device support portion of the single shoe-type brake apparatus according to the fifth embodiment of the present invention.

Referring to FIG. 10, in order to reduce the extension initiation force of the shoe, it is necessary to minimize the height h2 of the extendibility reduction depressions 200. In this case, during rapid braking, electronic stability control (ESC), or parking braking, high braking force is generated, and thus leaping force F1 is generated in the deformed sections of the extendibility reduction depressions 200 during the extension of the brake shoe. If this is not controlled, the deformed sections of the extendibility reduction depressions 200 are plastically deformed, and thus a braking disabled state may occur. In order to prevent this state from occurring, the auxiliary device is supported on the auxiliary device support portion 600.

FIG. 11 is a view showing extendibility reduction depressions configured to prevent a brake shoe from leaping during the extension of the brake shoe in the single shoe-type brake apparatus according to the fifth embodiment of the present invention.

Accordingly, as shown in the graph of FIG. 12, it can be seen that a structure (3) in which corrugated portions 200a are famed in extendibility reduction depressions 200 can ensure a more sufficient interval in which braking initiation force is linear within a shoe displacement range than a case (1) where extendibility reduction depressions 200 are not applied and a case (2) where only extendibility reduction depressions 200 are applied. The structure can effectively resolve the problem in which braking initiation force increases rapidly.

Furthermore, as shown in FIG. 11, a back plate 10 may be installed on one of the front and rear portions of a sideways “U”-shaped shoe to prepare for a situation in which the cylinder 400 is operated and thus the brake shoe is extended. In this case, the extendibility reduction depressions 200 may be formed in the front and rear portions of the shoe at the same height or at different heights.

Referring to FIG. 11, the extendibility reduction depressions 200 are preventing from leaping and being deformed via a structure, including the back plate 10 configured to support the brake shoe 100, a support plate 220, and a fastening member 230, thereby fastening the location of the shoe.

FIG. 3 shows the extension deformation section of the single shoe-type brake apparatus according to the second embodiment of the present invention. In FIG. 3, the extendibility reduction depressions 200 are shown. The height of sideways “U”-shaped shoe rails in the extendibility reduction depressions 200 is h1, and the height of the extendibility reduction depressions 200 is h2.

In other words, when the overall height is h, the height of rails in the extendibility reduction depressions 200 is h1, and the height of the extendibility reduction depression 200 is h2, the relationship h=h1+h2 is established. In this case, h2/h1 varies depending on the material, shape and extendibility of the shoe, and is generally within the range 1/3<h2/h1<3.

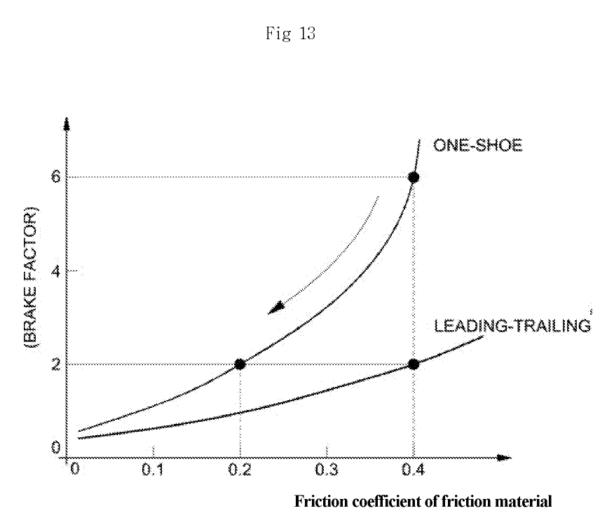

FIG. 13 is a graph showing the relationships between the brake factors of a single shoe-type brake apparatus and a leading-trailing-type brake apparatus and the friction coefficients of friction materials. Referring to this graph, in the case of the commonly commercialized leading-trailing-type brake apparatus, when the friction coefficient is 0.4, the brake factor becomes 2. In contrast, when the friction coefficient is applied to the single shoe-type brake apparatus, the brake factor becomes 6. Accordingly, it is impossible to apply the single shoe-type brake apparatus. Therefore, in the case of the single shoe-type brake apparatus according to the present invention, when a low friction coefficient equal to or lower than 0.25 is applied, the brake factor may be set to 2. According, this is a core concept of the present invention.

FIG. 13 is a graph showing the friction coefficients of the brake friction materials 300 and the brake factors of brakes, and indicates that the brake factor of a brake increases rapidly in accordance with the friction coefficient of the friction material 100. In order to reduce a rapid increase in operation initiation force which occurs during the rapid braking of a vehicle, reducing the friction coefficient of a friction material used in a single shoe-type brake apparatus is a core technology of the present invention. Accordingly, FIG. 13 shows relationships between friction coefficients and the brake factors of brakes.

FIGS. 9 and 11 show another embodiment in which an auxiliary device support structure having a back plate 10 configured to prevent a brake shoe from leaping is installed. The embodiment includes a body 200, a support plate 220, and a fastening member 230.

In this case, corrugated portions 200a may be formed in the brake shoe 100, as shown in FIG. 11. Since the operation and effects thereof are the same as those of the above-described embodiment, detailed descriptions thereof are omitted in the description of the present embodiment.

The support plate 220 is provided to couple the back plate 10 to the extendibility reduction depressions 200. The support plate 220 has a predetermined length, and is located upright in order to face the back plate 10 in the bottom end of the brake shoe 100.

The fastening member 230 is preferably a rivet or bolt. The fastening member 230 fastens the support plate 220 and the back plate 10 while passing through the support plate 220 and the back plate 10 in the state of supporting the bent end of the brake shoe 100 against the back plate 10 via the support plate 220 and the back plate 10.

Accordingly, in the present embodiment, the supporting and fastening structure is applied to the extendibility reduction depressions 200. Therefore, when external force generated in the cylinder 400 is applied to the separation region A by the rapid braking of a vehicle, the extendibility reduction depressions 200 can be deformed.

As a result, according to the present embodiment, the extendibility reduction depressions 200 facilitate the extension and contraction of the separation region A attributable to the braking of a vehicle, and thus the extendibility reduction depressions 200 can be prevented from being plastically deformed via the auxiliary device support portion 600 having the back plate 10, as shown in FIGS. 9 and 13. Accordingly, the brake apparatus according to the present embodiment can be used not only as a main brake but also as a parking brake.

The present invention is advantageous in that the extendibility reduction depressions, which may have various shapes and structures, are formed in the inner surface of the brake shoe to thus facilitate extension in order to reduce braking initiation force rapidly increasing in accordance with the wear of the friction material, thereby enabling extendibility regarding the separation region of the single shoe-type braking apparatus to be reduced.

Furthermore, according to another embodiment of the present invention, the back plate configured to support the brake shoe and the extendibility reduction depressions are coupled to each other by the support plate, and thus the extendibility reduction depressions can be prevented from being deformed when reaction force is generated due to external force applied to the separation region during rapid braking, thereby enabling the range of application of the brake apparatus to extend not only to a main brake but also to a parking brake.

According to the present invention, there is provided the single shoe-type brake apparatus, in which extendibility reduction depressions are formed in the inner surface of the sideways “U”-shaped brake shoe in order to reduce braking initiation force rapidly increasing in accordance with the wear of a friction material, and the extension and deformation of the brake shoe are performed via the extendibility reduction depressions in the case of the wear of the friction material, thereby reducing extendibility regarding the separation region of the sideways “U”-shaped brake shoe.

Furthermore, according to the present invention, there is provided the single shoe-type brake apparatus, in which braking force can be considerably reduced by means of the friction material having a friction coefficient significantly lower than that of a current commercialized friction material in order to meet the requirement in which a reduction in braking force is essential for the application of a single shoe-type brake as a common main brake for the reason that problems arise in that a rear axle is fastened earlier and an anti-lock braking system (ABS) operates frequently during braking when the single shoe-type brake having high performance is applied to the rear axle of a vehicle and thus a leading-trailing type brake having two shoes and reduced braking force is commonly applied to the rear axle of the vehicle.

Although the present invention has been described with reference to the embodiments shown in the drawings, this is merely illustrative. It will be appreciated by those having ordinary knowledge in the art that various modifications may be made and all or part of each of the described embodiments may be selectively combined. Therefore, the true range of protection of the present invention should be defined by the technical spirit of the attached claims.

1. A single shoe-type brake apparatus, comprising:
an integrated sideways “U”-shaped single brake shoe configured to form an open ring shape, to be integrated into a single body, and to have a separation region on one side thereof so that it is subjected to external force in a direction where it is extended to both sides thereof;
a cylinder installed in the separation region, and configured to provide the external force in a direction where the brake shoe is extended toward separate ends of the brake shoe; and
a friction material coupled to an outer circumferential surface of the brake shoe, and installed to selectively come into contact with a brake drum as the brake shoe is extended;
wherein a friction coefficient of the friction material is considerably lower than that of a common brake friction material, and a brake factor is almost identical to that of a brake apparatus having two shoes.

2. A single shoe-type brake apparatus, comprising:
an integrated sideways “U”-shaped single brake shoe configured to form an open ring shape, to be integrated into a single body, and to have a separation region on one side thereof so that it is subjected to external force in a direction where it is extended to both sides thereof;
extendibility reduction depressions formed in portions of an inner surface of the brake shoe opposite to the separation region to have a predetermined shape, and configured to reduce extendibility of the brake shoe;
a cylinder installed in the separation region, and configured to provide the external force in a direction where the brake shoe is extended toward separate ends of the brake shoe; and
a friction material coupled to an outer circumferential surface of the brake shoe, and installed to selectively come into contact with a brake drum as the brake shoe is extended;
wherein a friction coefficient of the friction material is considerably lower than that of a common brake friction material, and a brake factor is almost identical to that of a brake apparatus having two shoes.

3. The single shoe-type brake apparatus of claim 2, wherein the extendibility reduction depressions are formed in one or both of inner surfaces of rails of the sideways “U”-shaped shoe, and have corrugated portions including arcs whose heights are different.

4. The single shoe-type brake apparatus of claim 2, wherein the extendibility reduction depressions are formed in one or both of front and rear portions of rails of the sideways “U”-shaped, have an identical shape and structure or different shapes and structure, and are formed at an identical height or different heights.

5. The single shoe-type brake apparatus of claim 2, wherein both side ends of the extendibility reduction depressions are formed in a terminal shape or a step shape, or are formed in a moderate elliptical shape or an arcuate shape having a slight slope.

6. The single shoe-type brake apparatus of claim 2, wherein an auxiliary device support portion is formed between the extendibility reduction depressions.

7. The single shoe-type brake apparatus of claim 2, wherein an auxiliary device support portion is formed on one or both of front and rear portions of the sideways “U”-shaped shoe.

8. The single shoe-type brake apparatus of claim 2, wherein the extendibility reduction depressions are formed in front and rear portions of the sideways “U”-shaped shoe, and depths of the extendibility reduction depressions are identical to or different from each other.

9. The single shoe-type brake apparatus of claim 2, wherein the extendibility reduction depressions are formed to have differences in height, are formed to have stepwise differences in height, or are formed in various shapes, such as an elliptical shape or a circular shape, in accordance with performance of a brake.

10. The single shoe-type brake apparatus of claim 2, wherein the extendibility reduction depressions are formed without an auxiliary device support portion, and satisfy a relationship 1/3<h2/h1<3, wherein a height of rails in the extendibility reduction depressions is h1 and a depth of the extendibility reduction depression is h2.

11. A single shoe-type brake apparatus, comprising:
an integrated sideways “U”-shaped single brake shoe configured to form an open ring shape, to be integrated into a single body, and to have a separation region on one side thereof so that it is subjected to external force in a direction where it is extended to both sides thereof;
extendibility reduction depressions formed in portions of an inner surface of the brake shoe opposite to the separation region to have a predetermined shape, and configured to reduce extendibility of the brake shoe;
a cylinder installed in the separation region, and configured to provide the external force in a direction where the brake shoe is extended toward separate ends of the brake shoe;
a friction material coupled to an outer circumferential surface of the brake shoe, and installed to selectively come into contact with a brake drum as the brake shoe is extended; and
an auxiliary device configured to prevent the brake shoe from leaping when the brake shoe is extended by an operation of the cylinder;
wherein a friction coefficient of the friction material is considerably lower than that of a common brake friction material, and a brake factor is almost identical to that of a brake apparatus having two shoes.

12. The single shoe-type brake apparatus of claim 11, wherein the auxiliary device is formed on one side or a remaining side of the sideways “U”-shaped brake shoe.

13. The single shoe-type brake apparatus of claim 11, wherein the auxiliary device comprise:
a support plate located upright on a bent end of the extendibility reduction depressions; and
a fastening member configured to fasten the support plate and the back plate while passing through the support plate and the back plate in a state of supporting the bent end of the extendibility reduction depressions via the support plate and the back plate configured to support the brake shoe.

14. The single shoe-type brake apparatus of claim 11, wherein the extendibility reduction depressions include corrugated portions formed along portions of an inner surface of the brake shoe opposite to the separation region.

15. The single shoe-type brake apparatus of claim 11, wherein a length and height of an auxiliary device support portion formed between the extendibility reduction depressions are determined based on strength and extendibility of the brake shoe.

16. The single shoe-type brake apparatus of claim 11, wherein the friction coefficient of the friction material is equal to or lower than 0.25.
